(19) United States
(12) Patent Application Publication
(10) Pub. No.: US 2004/0171759 A1
(43) Pub. Date: Sep. 2, 2004

(54) Polymer composition containing at least one middle molecular weight reactive polyisobutene

(76) Inventors: Arno Lange, Bad Durkheim (DE); Stephan Huffer, Ludwigshafen (DE); Gabriele Lang, Mannheim (DE); Helmut Mach, Heidelberg (DE); Hans Peter Rath, Grunstadt (DE); Eckhard Schauss, Heuchelheim (DE)

Correspondence Address: NIXON & VANDERHYE, PC, 1100 N GLEBE ROAD, 8TH FLOOR, ARLINGTON, VA, 22201-4714, US

(21) Appl. No.: 10/486,162

(22) PCT Filed: Aug. 28, 2002
(86) PCT No.: PCT/EP02/09608

(30) Foreign Application Priority Data
Aug. 29, 2001 (DE) 101 42 285.7

(51) Int. Cl. C08F 8/00; C08L 23/00

(52) U.S. Cl. 525/192; 525/333.7; 525/333.9

(57) ABSTRACT

A polymer composition comprises at least one polyisobutene-containing component based on a medium molecular weight, reactive polyisobutene and at least one further polymer which is different therefrom.

### DESCRIPTION

The present invention relates to a polymer composition comprising at least one polyisobutene-containing component based on a medium molecular weight reactive polyisobutene and at least one further polymer which is different therefrom.

Organic polymers (plastics) can be classified according to very different criteria. An important class of polymers is made up of thermoplastics. Thermoplastics are linear polymers which are prepared by polyaddition (e.g. polystyrene) or polycondensation (e.g. polycarbonates and polyarylates from bisphenols). They can be amorphous (“vitreous” or “glass-like”) or crystalline or mixed amorphous and crystalline. Above the glass transition temperature (amorphous polymers) or the melting point, these polymers become capable of flow and can be processed by extrusion or injection molding. A further important class of polymers is made up of polymers having rubber-elastic properties (elastomers), i.e. polymers which have a low degree of crosslinking and glass transition temperatures of generally not more than 0° C. The crosslinking characteristic of elastomers can be irreversible via covalent chemical bonds or reversible via purely physical interactions. Irreversibly crosslinked elastomers are of great industrial and economic importance. They are produced, inter alia, by crosslinking (vulcanization) of natural and synthetic latices. A large part of them is used in the production of rubber articles. Reversibly crosslinked elastomers include, for example, block copolymers derived from styrene monomers and dienes, with physical crosslinking occurring via the latter. This gives the polymers specific processing properties such as thermoplasticity. Elastomers having thermoplastic properties (thermoplastic elastomers, thermoplastics) constitute a further important class of polymers which generally have a combination of the use properties of elastomers and the processing properties of thermoplastics. Thermoplastic elastomers have also found a wide range of uses and are employed, for example, for the production of seals, shock-absorbing or spring systems, hoses, etc. A particularly important group of thermoplastic elastomers is made up of polystyrenes, which can be used in the form of copolymers or blends to modify the properties, for example to improve the impact toughness.

The production of products based on polymers and having a complex property profile frequently presents difficulties. There is a great need for polymers which combine high fracture strength and abrasion resistance and also good adhesion at interfaces and simple processability with high (shape) stability. Depending on the use to which the polymers are put, a particular requirement is, in particular, a particular interfacial behavior. For the present purposes, interfaces (phase boundaries) are areas in general which separate two immiscible phases from one another (gas/liquid, gas/solid, liquid/solid, liquid/liquid, solid/solid). Applications include, for example, those in which adhesive, bonding or sealing action, flexibility, scratch resistance or fracture strength, etc., are required in combination with, for example, thermoplastic behavior. Market products which place high demands on the property profile of the polymers used therein include, for example, adhesives, adhesion promoters, sealing compositions (sealants), industrial rubber products, prepolymers for vulcanization, engineering plastics for producing housings, handles, tools or other industrial articles.

It is known that polymer compositions comprising two or more polymers can be used to achieve particular product properties. A problem which is frequently observed in such compositions is incompatibility of the polymers which are formulated together to achieve particular properties. This can, for example, show up as partial demixing and “sweating out” of a component. There is a continual need for polymer compositions which firstly have the desired properties and secondly are sufficiently stable to demixing.

WO-A-01/10969 describes the use of linear or star-shaped block copolymers which have at least one polymer block consisting essentially of isobutene units and at least two polymer blocks consisting essentially of units derived from vinylaromatic monomers as elastic sealing material.

It is an object of the present invention to provide a polymer composition which has good mechanical properties and/or good interfacial properties, is easy to process and is stable to demixing.

We have found that this object is achieved by a polymer composition comprising:

a) at least one polyisobutene-containing component selected from among medium molecular weight, reactive polyisobutene having a number average molecular weight Mₙ in the range from 5000 to 80,000 dalton and a content of terminal double bonds of at least 50 mol %, derivatives of this medium molecular weight, reactive polyisobutene and mixtures thereof,

b) at least one polymer which is different from a).

For the purposes of the present invention, a polymer composition is a composition which may be a pure mixture in the sense of incorporation of a component a) into the component b) (compound), a composition in which the components interact via purely physical phenomena or a composition in which the components form covalent bonds. Covalent bonds can be formed both between the compounds of only one component a) or b) and between a compound of the component a) and a compound of the component b). This can be the case, for example, when the component a) comprises a reactive polyisobutene which, according to the definition, has terminal double bonds. In such a case, it is possible, for example, for a reaction to occur between the double bonds of the polyisobutene or for at least partial grafting onto a further polyisobutene chain or the component b) to occur. However, other mechanisms are also conceivable. Thus, a reaction between complementary functional groups of at least one compound of the component a) and at least one compound of the component b) can be induced quite generally by appropriate choice of the conditions (temperature, electromagnetic radiation, addition of catalyst). Suitable compounds of components a) and b), suitable complementary functional groups and reaction conditions are described below.

The component a) is a polyisobutene-containing component based on medium molecular weight, reactive polyisobutenes. “Reactive” polyisobutenes are differentiated from “relatively unreactive” polyisobutenes by the content of double bonds in the α or β position. The component a) preferably comprises at least one polyisobutene having a proportion of α- and/or β-double bonds of at least 50 mol %, particularly preferably at least 60 mol % and especially at least 80 mol %, and/or a derivative thereof.

The medium molecular weight polyisobutenes used according to the present invention have a number average molecular weight Mₙ in the range from about 5000 to 80,000 dalton, preferably from 10,000 to 50,000 dalton and especially from 20,000 to 40,000 dalton. They differ in this way from low molecular weight polyisobutenes having molecular weights of less than 5000 dalton and high molecular weight polyisobutenes having molecular weights up to several hundred thousand dalton.

The polyisobutenes used according to the present invention preferably have a narrow molecular weight distribution. Their polydispersity (M_{w}/Mₙ) is preferably in a range from 1.05 to 4, for example from 2 to 3. However, it can, if desired, also be higher, e.g. greater than 5 or even greater than 12.

The polyisobutenes used according to the present invention are preferably substantially homopolymeric polyisobutenes.

For the purposes of the present invention, a substantially homopolymeric polyisobutene is a polyisobutene which comprises more than 90% by weight of isobutene units. Suitable comonomers are C₃-C₆-alkenes, preferably n-butene. Preparation and structure of oligoisobutenes/polyisobutenes are known to those skilled in the art (e.g. Günther, Maenz, Stadermann in Ang. Makrom. Chem. 234, 71 (1996)).

Preference is given to using polyisobutenes which, if desired, may contain up to 10% of n-butene as copolymerized comonomer. Such polyisobutenes are prepared, for example, from butadiene-free C₄ fractions which generally, as a result of the production method, comprise isobutene together with n-butene. Particular preference is given to isobutene homopolymers.

Particularly useful reactive polyisobutenes are, for example, the Oppanol® grades from BASF Aktiengesellschaft, e.g. B10-SFN, B12-SFN, B15-SFN (number average molecular weight Mₙ=18,000, 25,000, 32,000 dalton). Particular preference is given to polyisobutenes in which at least 60 mol % of the end groups are methylvinylidene groups (—C(—CH₃)═CH₂) and/or dimethylvinyl groups (—CH═C(CH₃)₂).

Suitable medium molecular weight, reactive polyisobutenes and methods of preparing them are described in EP-A-0 807 641, which is hereby fully incorporated by reference.

In a preferred embodiment, the polymer compositions of the present invention comprise, as component a), at least one polyisobutene derivative which is obtainable by reaction of at least part of the double bonds present in a medium molecular weight, reactive polyisobutene in a single-stage or multistage functionalization selected from among:

i) reaction with a compound containing at least one aromatic or heteroaromatic group in the presence of an alkylation catalyst to give a compound alkylated by polyisobutene,

ii) reaction with a peroxy compound to give an at least partially epoxidized polyisobutene,

iii) reaction with an alkene which has an electrophilically substituted double bond (enophile) in an ene reaction,

iv) reaction with carbon monoxide and hydrogen in the presence of a hydroformylation catalyst to give an at least partially hydroformylated polyisobutene,

v) reaction with hydrogen sulfide or a thiol to give a polyisobutene which is at least partially functionalized by thio groups,

vi) reaction with a silane in the presence of a silylation catalyst to give a polyisobutene which is at least partially functionalized by silyl groups,

vii) reaction with a halogen or a hydrogen halide to give an at least partially halogenated polyisobutene,

viii) reaction with a borane and subsequent oxidative cleavage to give an at least partially hydroxylated polyisobutene, and

ix) reaction with SO₃ or a compound capable of releasing SO₃ to give a polyisobutene which is at least partially functionalized by sulfo groups.

i) Alkylation

To produce the derivative, a medium molecular weight, reactive polyisobutene can be reacted with a compound which contains at least one aromatic or heteroaromatic group in the presence of an alkylation catalyst. Suitable aromatic and heteroaromatic compounds, catalysts and reaction conditions for this Friedel-Crafts alkylation are described, for example, in J. March, Advanced Organic Chemistry, 4th edition, John Wiley & Sons, pp. 534-539, which is hereby incorporated by reference.

The alkylation is preferably carried out using an activated aromatic compound. Suitable aromatic compounds are, for example, alkoxyaromatics, hydroxyaromatics or activated heteroaromatics such as thiophenes.

The aromatic hydroxy compound used for the alkylation is preferably selected from among phenolic compounds which have 1, 2 or 3 OH groups and may bear at least one further substituent.

Preferred further substituents are C₁-C₈-alkyl groups, in particular methyl and ethyl. Particular preference is given to compounds of the formula,

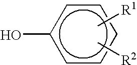

where R¹ and R² are each, independently of one another, hydrogen, OH or CH₃. Particular preference is given to phenol, the isomeric cresols, catechol, resorcinol, pyrogallol, fluoroglucinol and the isomeric xylenols. In particular, phenol, o-cresol and p-cresol are used. If desired, mixtures of the abovementioned compounds can also be used for the alkylation.

The catalyst is preferably selected from among Lewis-acid alkylation catalysts, which, for the purposes of the present invention, include both single acceptor atoms and acceptor ligand complexes, molecules, etc., provided that these display overall Lewis-acid (electron acceptor) properties toward other chemical species. Examples include AlCl₃, AlBr₃, BF₃, BF₃·2 C₆H₅OH, BF₃[(C₂H₅)₂]₂, TiCl₄, SnCl₄, AlC₂H₅Cl₂, FeCl₃, SbCl₅ and SbF₅. These alkylation catalysts can be used together with a cocatalyst, for example an ether. Suitable ethers are di(C₁-C₈-alkyl) ethers such as dimethyl ether, diethyl ether, di-n-propyl ether and also tetrahydrofuran, di(C₅-C₈-cycloalkyl) ethers such as dicyclohexyl ether and ethers containing at least one aromatic hydrocarbon radical, e.g. anisole. If a catalyst-cocatalyst complex is used for the Friedel-Crafts alkylation, the molar ratio of catalyst to cocatalyst is preferably in a range from 1:10 to 10:1. The reaction can also be catalyzed by protic acids such as sulfuric acid, phosphoric acid, trifluoromethanesulfonic acid. Organic protic acids can also be present in polymerically bound form, for example as ion exchange resin.

The alkylation can be carried out in the absence of solvents or in a solvent. Suitable solvents are, for example, n-alkanes and mixtures thereof and alkylaromatics, e.g. toluene, ethylbenzene and xylene, and also halogenated derivatives thereof.

The alkylation is preferably carried out at from −10° C. to +100° C. The reaction is usually carried out at atmospheric pressure, but can also be carried out at higher or lower pressures.

Appropriate choice of the molar ratios of aromatic or heteroaromatic compound to polyisobutene and the catalyst makes it possible to set the proportion of alkylated products and their degree of alkylation in a targeted manner. Essentially monoalkylated polyisobutenylphenols are generally obtained using an excess of phenol or in the presence of a Lewis-acid alkylation catalyst when an ether is additionally used as cocatalyst.

For further functionalization, a polyisobutenylphenol obtained in step i) can be subjected to a Mannich reaction with at least one aldehyde, for example formaldehyde, and at least one amine having at least one primary or secondary amine function to give a compound which is alkylated by polyisobutene and additionally at least partially aminoalkylated. It is also possible to use reaction and/or condensation products of aldehyde and/or amine. The preparation of such compounds is described in WO 01/25 293 and WO 01/25 294, which are hereby fully incorporated by reference.

ii) Epoxidation

The functionalization can be carried out by reacting a medium molecular weight, reactive polyisobutene with at least one peroxy compound to give an at least partially epoxidized polyisobutene. Suitable epoxidation methods are described in J. March, Advanced Organic Chemistry, 4th edition, John Wiley & Sons, pp. 826-829, which is hereby incorporated by reference. Preference is given to using at least one peracid such as m-chloroperbenzoic acid, performic acid, peracetic acid, trifluoroperacetic acid, perbenzoic acid or 3,5-dinitroperbenzoic acid as peroxy compound. The peracids can be prepared in situ from the corresponding acids and H₂O₂, if appropriate in the presence of mineral acids. Further suitable epoxidation reagents are, for example, alkaline hydrogen peroxide, molecular oxygen and alkyl peroxides such as tert-butyl hydroperoxide. Suitable solvents for the epoxidation are, for example, customary nonpolar solvents. Particularly useful solvents are hydrocarbons such as toluene, xylene, hexane and heptane.

iii) Ene Reaction

The functionalization can be carried out by reacting a medium molecular weight, reactive polyisobutene with at least one alkene having an electrophilically substituted double bond in an ene reaction (cf., for example, DE-A 4 319 672 or H. Mach and P. Rath in “Lubrication Science II (1999), pp. 175-185, which is hereby fully incorporated by reference). In the ene reaction, an alkene having an allylic hydrogen atom, which is designated as ene, is reacted with an electrophilic alkene, the enophile, in a pericyclic reaction comprising formation of a carbon-carbon bond, a double bond shift and a hydrogen transfer. In the present case, the medium molecular weight, reactive polyisobutene reacts as ene. Suitable enophiles are compounds which are also used as dienophiles in the Diels-Alder reaction. Preference is given to using maleic anhydride as enophile. This results in polyisobutenes which are at least partially functionalized by succinic anhydride groups.

The ene reaction can, if appropriate, be carried out in the presence of a Lewis acid as catalyst. Suitable Lewis acids are, for example, aluminum chloride and ethylaluminum chloride.

For further functionalization, it is possible, for example, to subject a polyisobutene functionalized by succinic anhydride groups to a subsequent reaction which is selected from among:

α) reaction with at least one amine to give a polyisobutene which is at least partially functionalized by succinimide groups and/or succinamide groups,

β) reaction with at least one alcohol to give a polyisobutene which is at least partially functionalized by succinic ester groups, and

γ) reaction with at least one thiol to give a polyisobutene which is at least partially functionalized by succinic thioester groups.

iv) Hydroformylation

The functionalization can be carried out by subjecting a medium molecular weight, reactive polyisobutene to a reaction with carbon monoxide and hydrogen in the presence of a hydroformylation catalyst, giving an at least partially hydroformylated polyisobutene.

Suitable hydroformylation catalysts are known and preferably comprise a compound or a complex of an element of transition group VIII of the Periodic Table, e.g. Co, Rh, Ir, Ru, Pd or Pt. To influence the activity and/or selectivity, preference is given to using hydroformylation catalysts which are modified by means of N- or P-containing ligands. Suitable salts of these metals are, for example, the hydrides, halides, nitrates, sulfates, oxides, sulfides or the salts of alkylcarboxylic or arylcarboxylic acids or alkylsulfonic or arylsulfonic acids. Suitable complexes have ligands which are, for example, selected from among halides, amines, carboxylates, acetylacetonate, arylsulfonates and alkylsulfonates, hydride, CO, olefins, dienes, cycloolefins, nitriles, N-containing heterocycles, aromatics and heteroaromatics, ethers, PF₃, phosphols, phosphabenzenes and monodentate, bidentate and polydentate phosphine, phosphinite, phosphonite, phosphoramidite and phosphite ligands.

In general, the catalyst or catalyst precursors used in each case are converted under hydroformylation conditions into catalytically active species of the formula HₓM_{y}(CO)_{z}L_{q}, where M is a metal of transition group VIII, L is a ligand and q, x, y, z are integers which depend on the valence and type of the metal and the number of coordination sites occupied by the ligand L.

In a preferred embodiment, the hydroformylation catalysts are prepared in situ in the reactor used for the hydroformylation reaction.

In another preferred embodiment, use is made of a carbonyl generator in which previously prepared carbonyl is adsorbed on, for example, activated carbon and only the desorbed carbonyl but not the salt solutions from which the carbonyl is produced is introduced into the hydroformylation.

Suitable rhodium compounds or complexes are, for example, rhodium(II) and rhodium(III) salts, e.g. rhodium(III) chloride, rhodium(III) nitrate, rhodium(III) sulfate, potassium rhodium sulfate, rhodium(II) or rhodium(III) carboxylates, rhodium(II) and rhodium(III) acetate, rhodium(III) oxide, salts of rhodic(III) acid, trisammonium hexachlororhodate(III), etc. Also suitable are rhodium complexes such as dicarbonyl rhodium acetylacetonate, acetylacetonatobisethylenerhodium(I), etc.

Further suitable catalyst precursors are ruthenium salts or compounds. Suitable ruthenium salts are, for example, ruthenium(III) chloride, ruthenium(IV) oxide, ruthenium(VI) oxide or ruthenium(VIII) oxide, alkali metal salts of ruthenium oxo acids, e.g. K₂RuO₄ or KRuO₄, or complexes such as RuHCl(CO)(PPh₃)₃. It is also possible to use the carbonyls of ruthenium such as dodecacarbonyl triruthenium or octadecacarbonyl hexaruthenium, or mixed forms in which CO is partially replaced by ligands of the formula PR₃, e.g. Ru(CO)₃(PPh₃)₂.

Suitable cobalt compounds are, for example, cobalt(II) chloride, cobalt(II) sulfate, cobalt(II) carbonate, cobalt(II) nitrate, their amine or aquo complexes, cobalt carboxylates such as cobalt formate, cobalt acetate, cobalt ethylhexanoate, cobalt naphthenoate, and also the cobalt-caprolactam complex. Here too, it is possible to use carbonyl complexes of cobalt, e.g. octacarbonyl dicobalt, dodecacarbonyl tetracobalt and hexadecacarbonylhexacobalt.

The abovementioned compounds and further suitable compounds are known in principle and are adequately described in the literature.

Suitable activating agents which can be used for hydroformylation are, for example, Bröbnsted acids, Lewis acids such as BF₃, AlCl₃, ZnCl₂, and Lewis bases.

The composition of the synthesis gas comprising carbon monoxide and hydrogen can vary within a wide range. The molar ratio of carbon monoxide to hydrogen is generally from about 5:95 to 95:5, preferably from about 40:60 to 60:40. The temperature in the hydroformylation is generally in a range from about 20 to 200° C., preferably from about 50 to 190° C. The reaction is generally carried out at the partial pressure of the reaction gas at the reaction temperature selected. In general, the pressure is in a range from about 1 to 700 bar, preferably from 1 to 300 bar.

The carbonyl number of the hydroformylated polyisobutenes obtained depends on the number average molecular weight Mₙ. Products having a number average molecular weight Mₙ of 10,000 dalton preferably have carbonyl numbers of from 2 to 5.6 mg KOH/g, in particular from 3.6 to 5.6 mg KOH/g. Products having a number average molecular weight Mₙ of 40,000 dalton have carbonyl numbers of from 0.5 to 1.4 mg KOH/g, in particular from 0.9 to 1.4 mg KOH/g. The carbonyl numbers of products having other molecular weights can be determined by interpolation or extrapolation.

It is preferred that the major part of the double bonds present in the medium molecular weight, reactive polyisobutene used is converted into aldehydes by the hydroformylation. The use of suitable hydroformylation catalysts and/or an excess of hydrogen in the synthesis gas used also makes it possible to convert the major part of the ethylenic double bonds present in the starting material directly into alcohols. This can also be achieved in a two-stage functionalization as in the reaction step B) described below.

The functionalized polyisobutenes obtained by hydroformylation can advantageously be used as intermediates for further processing by functionalization of at least part of the aldehyde functions present in them.

A) Oxo Carboxylic Acids

For further functionalization, the hydroformylated polyisobutenes obtained in step iv) can be reacted with an oxidant to give a polyisobutene which is at least partially functionalized by carboxyl groups.

Aldehydes can be oxidized to carboxylic acids using a large number of different oxidants and oxidation processes, as described, for example, in J. March, Advanced Organic Chemistry, John Wiley & Sons, 4th edition, p. 701ff. (1992). They include, for example, oxidation by means of permanganate, chromate, atmospheric oxygen, etc. Oxidation using air can be carried out either catalytically in the presence of metal salts or in the absence of catalysts. Preferred metals are ones which are capable of a valence change, e.g. Cu, Fe, Co, Mn, etc. The reaction can generally also be carried out in the absence of a catalyst. In the case of oxidation using air, the conversion can easily be controlled via the reaction time.

In a further embodiment, an aqueous hydrogen peroxide solution in combination with a carboxylic acid, e.g. acetic acid, is used as oxidant. The acid number of the resulting polyisobutenes having carboxyl functions depends on the number average molecular weight Mₙ. Products having a number average molecular weight Mₙ of 10,000 dalton preferably have acid numbers of from 2 to 5.6 mg KOH/g, in particular from 3.6 to 5.6 mg KOH/g. Products having a number average molecular weight Mₙ of 40,000 dalton have acid numbers of from 0.5 to 1.4 mg KOH/g, in particular from 0.9 to 1.4 mg KOH/g.

The acid numbers of products having other molecular weights can be determined by interpolation or extrapolation.

B) Oxo Alcohols

In a further useful embodiment, the hydroformylated polyisobutenes obtained in step iv) can be subjected to a reaction with hydrogen in the presence of a hydrogenation catalyst to give a polyisobutene which is at least partially functionalized by alcohol groups.

Suitable hydrogenation catalysts are generally transition metals such as Cr, Mo, W, Fe, Rh, Co, Ni, Pd, Pt, Ru, etc., or mixtures thereof which can be applied to supports such as activated carbon, aluminum oxide, kieselguhr, etc., to increase the activity and stability. To increase the catalytic activity, Fe, Co, and preferably Ni can also be used in the form of Raney catalysts as metal sponge having a very large surface area.

The hydrogenation of the oxo aldehydes from step iv) is, depending on the activity of the catalyst, preferably carried out at elevated temperatures and superatmospheric pressure. The reaction temperature is preferably from about 80 to 150° C and the pressure is preferably from about 50 to 350 bar.

The alcohol number of the resulting hydroxyl-functionalized polyisobutenes depends on the number average molecular weight Mₙ. Products having a number average molecular weight Mₙ of 10,000 dalton preferably have alcohol numbers of from 2 to 5.6 mg KOH/g, in particular from 3.6 to 5.6 mg KOH/g. Products having a number average molecular weight Mₙ of 40,000 dalton have alcohol numbers of from 0.5 to 1.4 mg KOH/g, in particular from 0.9 to 1.4 mg KOH/g. The alcohol numbers of products having other molecular weights can be determined by interpolation or extrapolation.

C) Amine Synthesis

In a further useful embodiment, the hydroformylated polyisobutenes obtained in step iv) are further functionalized by reaction with hydrogen and ammonia or a primary or secondary amine in the presence of an amination catalyst to give a polyisobutene which is at least partially functionalized.by amine groups.

Suitable amination catalysts are the hydrogenation catalysts described above for step B), preferably copper, cobalt or nickel which can be used in the form of the Raney metals or on a support. Platinum catalysts are also suitable.

Amination with ammonia gives aminated polyisobutenes having primary amino functions. Primary and secondary amines which are suitable for the amination are compounds of the formulae R—NH₂ and RR′NH, where R and R′ are, for example, C₁-C₁₀-alkyl, C₆-C₂₀-aryl, C₇-C₂₀-arylalkyl, C₇-C₂₀-alkylaryl or cycloalkyl.

The amine number of the resulting polyisobutenes having amino functions depends on the number average molecular weight Mₙ. Products having a number average molecular weight Mₙ, of 10,000 dalton preferably have amine numbers of from 2 to 5.6 mg KOH/g, in particular from 3.6 to 5.6 mg KOH/g. Products having a number average molecular weight Mₙ of 40,000 dalton have amine numbers of from 0.5 to 1.4 mg KOH/g, in particular from 0.9 to 1.4 mg KOH/g. The amine numbers of products having other molecular weights can be determined by interpolation or extrapolation.

v) Addition of Hydrogen Sulfide and Thiols

Functionalization can be carried out by reacting a medium molecular weight, reactive polyisobutene with hydrogen sulfide or a thiol, e.g. an alkyl or aryl thiol, a hydroxymercaptan, an aminomercaptan, a thiocarboxylic acid or a silane thiol, to give a polyisobutene which is at least partially functionalized by thio groups. Suitable hydro-alkylthio additions are described in J. March, Advanced Organic Chemistry, 4th edition, John Wiley & Sons, pp. 766-767, which is hereby fully incorporated by reference. The reaction can generally be carried out either in the absence or in the presence of initiators and also in the presence of electromagnetic radiation. The addition of hydrogen sulfide gives polyisobutenes functionalized by thiol groups. Reaction with thiols in the absence of initiators generally gives the Markovnikov addition products onto the double bond. Suitable initiators for the hydro-alkylthio addition are, for example, protic and Lewis acids, e.g. concentrated sulfuric acid or AlCl₃. Further suitable initiators are substances which are capable of forming free radicals. Hydro-alkylthio addition in the presence of these initiators generally gives the anti-Markovnikov addition products. The reaction can also be carried out in the presence of electromagnetic radiation having a wavelength of from 400 to 10 nm, preferably from 200 to 300 nm.

vi) Silylation

Functionalization can be carried out by reacting a medium molecular weight, reactive polyisobutene with a silane in the presence of a silylation catalyst to give a polyisobutene which is at least partially functionalized by silyl groups.

Suitable hydrosilylation catalysts are, for example, transition metal catalysts, with the transition metal preferably being selected from among Pt, Pd, Rh, Ru and Ir. Suitable platinum catalysts include, for example, platinum in finely divided form (“platinum black”), platinum chloride and platinum complexes such as hexachloroplatinic acid. Suitable rhodium catalysts are, for example, (RhCl(P(C₆H₅)₃)₃) and RhCl₃. Also suitable are RuCl₃ and IrCl₃. Further suitable catalysts include Lewis acids such as AlCl₃ or TiCl₄ and also peroxides. It may be advantageous to use combinations or mixtures of the abovementioned catalysts.

Suitable silanes are, for example, halogenated silanes such as trichlorosilane, methyldichlorosilane, dimethylchlorosilane and trimethylsiloxydichlorosilane; alkoxysilanes such as trimethoxysilane, triethoxysilane, methyldimethoxysilane, phenyldimethoxysilane, 1,3,3,5,5,7,7-heptamethyl-1,1-dimethoxytetrasiloxane and also acyloxysilanes.

The reaction temperature in the silylation is preferably in a range from 0 to 120° C., particularly preferably from 40 to 100° C. The reaction is usually carried out under atmospheric pressure, but can also be carried out at superatmospheric pressures, e.g. in the range from about 1.5 to 20 bar, or reduced pressures, e.g. from 200 to 600 mbar.

The reaction can be carried out in the absence of solvents or in the presence of a suitable solvent. Preferred solvents are, for example, toluene, tetrahydrofuran and chloroform.

vii) Addition of Hydrogen Halide or Halogen

The functionalization can be carried out by reacting a medium molecular weight, reactive polyisobutene with hydrogen halide or a halogen to give an at least partially halogenated polyisobutene. Suitable reaction conditions for the hydro-halo addition are described in J. March, Advanced Organic Chemistry, 4th edition, John Wiley & Sons, pp. 758-759, which is hereby incorporated by reference. Hydrogen halides suitable for the addition reaction are in principle HF, HCl, HBr and HI. The addition of HI, HBr and HF can generally be carried out at room temperature, while the addition of HCl is generally carried out using elevated temperatures.

The addition of hydrogen halides can in principle be carried out in the absence or in the presence of initiators or of electromagnetic radiation. Addition in the absence of initiators, especially of peroxides, generally gives the Markovnikov addition products. When peroxides are added, the addition of HBr generally leads to anti-Markovnikov products.

The halogenation of double bonds is described in J. March, Advanced Organic Chemistry, 4th edition, John Wiley & Sons, pp. 812-814, which is hereby incorporated by reference. For addition of Cl, Br and I, the free halogens can be used. The use of interhalogen compounds is known for obtaining compounds having mixed halogenation. For the addition of fluorine, use is generally made of fluorine-containing compounds such as CoF₃, XeF₂ and mixtures of PbO₂ and SF₄. Bromine generally adds on to double bonds at room temperature to give good yields of the addition products. In the case of the addition of chlorine, it is possible to use not only the free halogen but also chlorine-containing reagents such as SO₂Cl₂, PCl₅ etc.

If halogenation is carried out using chlorine or bromine in the presence of electromagnetic radiation, the products obtained are essentially products of free-radical substitution on the polymer chain and not (or only to a minor extent) addition products onto the terminal double bond.

viii) Hydroboration

Functionalization can be carried out by subjecting a medium molecular weight, reactive polyisobutene to reaction with a borane (which may have been generated in situ) to give an at least partially hydroxylated polyisobutene. Suitable hydroboration methods are described in J. March, Advanced Organic Chemistry, 4th edition, John Wiley & Sons, pp. 783-789, which is hereby incorporated by reference. Suitable hydroboration reagents are, for example, diborane, which is usually generated in situ by reaction of sodium borohydride with BF₃ etherate, diisoamylborane (bis[3-methylbut-2-yl]borane), 1,1,2-trimethylpropylborane, 9-borabicyclo[3.3.1]nonane, diisocamphylborane, which are obtainable by hydroboration of the corresponding alkenes by means of diborane, chloroborane-dimethyl sulfide, alkyldichloroboranes or H₃B—N(C₂H₅)₂.

The hydroboration is usually carried out in a solvent. Suitable solvents for the hydroboration are, for example, acyclic ethers such as diethyl ether, methyl tert-butyl ether, dimethoxyethane, diethylene glycol dimethyl ether, triethylene glycol dimethyl ether, cyclic ethers such as tetrahydrofuran or dioxane and also hydrocarbons such as hexane or toluene or mixtures thereof. The reaction temperature is generally determined by the reactivity of the hydroboration agent and is normally in the range from the melting point to the boiling point of the reaction mixture, preferably in the range from 0° C. to 60° C.

The hydroboration agent is usually used in an excess over the alkene. The boron atom preferentially adds on to the less substituted and thus less sterically hindered carbon atom.

The alkylboranes formed are usually not isolated, but are converted directly into the desired products by subsequent reaction. A very important reaction of the alkylboranes is the reaction with alkaline hydrogen peroxide to give an alcohol which preferably corresponds formally to the anti-Markovnikov hydration of the alkene. Furthermore, the alkylboranes obtained can be subjected to reaction with bromine in the presence of hydroxide ions to give the bromide.

ix) Sulfonation

Functionalization can also be carried out by sulfonating an intermediate molecular weight, reactive polyisobutene. Suitable sulfonation processes are known to those skilled in the art and are described, for example, by Storey and Lee (J. Polym. Sci. A, 29, 317-325 (1991)), Kennedy und Storey (ACS Org. Coat. Appl. Polym. Sci. Proc. 46, 182 (1982)), by Bagrodia, Wilkes, Kennedy (J. Appl. Polym. Sci. 30, 2179-93 (1985)) and in WO 01/70830, which are hereby fully incorporated by reference.

Suitable sulfonating agents are, for example, SO₃, SO₃ adducts such as pyridine-SO₃ or dioxane-SO₃ or compounds such as acetyl sulfate which can release SO₃. The acetyl sulfate can also be prepared in situ from sulfuric acid and acetic anhydride.

Depending on the desired degree of sulfonation, the sulfonation reagent can be used in an excess or a deficiency, e.g. in an amount in the range from 1:0.7 to 1:4 (mole of olefin:mole of reagent). Preference is given to a range from 1:0.9 to 1:2.5.

The reaction temperature is from −30 to 150° C., preferably from 0 to 100° C. The reaction is usually carried out under atmospheric pressure, but a higher pressure (e.g. 1, 5 or 20 bar) or lower pressure (e.g. 200 or 600 mbar) can also be advantageous.

The reaction can be carried out in the absence of solvents or preferably in an inert organic solvent which is inert under the reaction conditions, e.g. in aliphatic hydrocarbons such. as pentane, hexane or heptane or hydrocarbon mixtures.

The polyisobutenes obtained in the sulfonation, which have been at least partially functionalized with sulfonic acid groups, can be converted at least partially into salts by reaction with a base. Suitable bases are, for example, alkali metals, alkaline earth metals or earth metals and also their oxides, hydroxides, carbonates and hydrogencarbonates, e.g. Li, Na, K, Ca, Mg, Al, Li₂CO₃, Na₂CO₃, K₂CO₃, CaCO₃, NaOH, KOH, CaO and MgO. It is likewise possible to use NH₃, e.g. as a solution in water, or organic amines for preparing the salts.

The invention also provides a process for preparing a polyisobutene derivative by reaction of at least part of the double bonds present in a medium molecular weight, reactive polyisobutene in a single-stage or multistage functionalization selected from among the reaction steps i) to ix) described above.

The present invention also provides the polyisobutene derivatives which are obtainable by such a process.

The medium molecular weight, reactive polyisobutenes used according to the present invention and their above-described derivatives which are provided by the invention or used according to the invention are advantageous for producing polymer compositions having good interfacial properties and/or good long-term mechanical properties. Thus, the polymer compositions obtained have, for example, a very good adhesive or sealing action, adhesion and/or flexibility. They are also advantageous for improving the abrasion resistance and/or scratch resistance of polymer surfaces. Furthermore, medium molecular weight, reactive polyisobutenes and their derivatives display good compatibility with a large number of polymers. This may be due to an ability to undergo a physical interaction with these polymers and also to an ability to form covalent bonds. The polymer compositions of the present invention thus display, advantageously, only a very slight tendency to undergo demixing, which in the case of polymer compositions known from the prior art is reflected, for example, in sweating out of one of the components.

In a first preferred embodiment, the component b) is selected from among elastomers having a glass transition temperature T_{G} of not more than 0° C., preferably not more than −10° C.

The elastomer is preferably selected from among acrylate rubbers (ACM), chlorosulfonated polyethylene (A-CSM), copolymers of alkyl acrylates with ethylene (AEM), polyester urethanes (AU), brominated butyl rubbers (BIIR), polybutadiene (BR), chlorinated butyl rubbers (CIIR), chlorinated polyethylene (CM), epichlorohydrin (CO), polychloroprene (CR), sulfurated polyethylene (CSM), ethylene oxide-epichlorohydrin copolymers (ECO), ethylene-acrylonitrile copolymers (ENM), epoxidized natural rubbers (ENR), ethylene-propylene-diene terpolymers (EPDM), ethylene-propylene copolymers (EPM), polyether urethanes (EU), ethylene-vinyl acetate copolymers (EVM), fluorinated rubbers (FKM), fluorosilicone rubbers (FVMQ), propylene oxide-allyl glycidyl ether copolymers (GPO), isobutene-isoprene copolymers (IIR), isoprene rubbers (IR), nitrile rubbers (NBR), natural rubber (NR), thioplastics (OT), styrene-butadiene rubbers (SBR), carboxyl-containing acrylonitrile-butadiene rubbers (XNBR), carboxyl-containing styrene-butadiene rubbers and mixtures thereof.

The component b) of the polymer composition of the present invention preferably comprises at least one elastomer which has at least one aromatic and/or heteroaromatic group. These elastomers preferably comprise styrene and/or a styrene derivative in copolymerized form. The component b) particularly preferably comprises a styrene-butadiene elastomer. In such elastomers, the butadiene is preferably 1,4-linked, but some 1,2-linkage may also be present. Preference is given to styrene-butadiene elastomers having a styrene content of from 10 to 70% by weight, preferably from 20 to 40% by weight, based on the total amount of the monomers to be polymerized. Styrene-butadiene elastomers have become widespread as synthetic rubber and are employed, for example, in shoe soles, conveyor. belts and further industrial articles. The polymer compositions of the present invention which comprise at least one polyisobutene-containing component a) and at least one styrene-butadiene elastomer b) have a high abrasion resistance and good compatibility of the components.

A further preferred embodiment constitutes polymer compositions comprising:

a) at least one polyisobutene-containing component based on a medium molecular weight, reactive polyisobutene which comprises at least one compound containing at least one functional group which is capable of reacting with a complementary functional group of a compound of the component b),

b) at least one polymer component which is different from a) and comprises at least one compound containing at least one functional group which is capable of reacting with a complementary functional group of a compound of the component a),

c) if desired, at least one compound selected from among photoinitiators, compounds capable of forming thermal free radicals and catalysts, and

d) customary additives.

For the purposes of the present invention, the term “complementary functional groups” refers to a pair of functional groups which can react with one another to form a covalent bond. “Complementary compounds” are pairs of compounds which have mutually complementary functional groups. The component b) is not restricted to compounds having elastomeric properties.

Preferred complementary functional groups of the compounds of the components a) and b) are selected from among the complementary functional groups in the overview below.

| Component a) | Component b) |
|---|---|
| Terminal double bond | Aromatic group |
| | heteroaromatic group |
| | —SH, —SiR₂H, enophile |
| Epoxy | —OH |
| | —COOH, —SH, —NHR, —NR₂ |
| Carboxylic anhydride | —OH, —SH |
| | —NH₂ |
| —OH | —NCO, —CR₂Hal |
| | epoxy |
| | carboxylic anhydride, —COOH |
| —COOH | Epoxy |
| | —SH, —OH |
| —NH₂ | Carboxylic anhydride, —COOH, |
| | —CH₂Hal |
| —SH | —COOH, —SH |
| —Si(OR)₃ | —Si(OR₃), —OH, —NH₂ |

The component a) preferably comprises at least one medium molecular weight, reactive polyisobutene having terminal double bonds and the component b) preferably contains at least one aromatic and/or heteroaromatic group. The formation of covalent bonds then preferably occurs in the presence of a catalyst suitable for Friedel-Crafts alkylation under reaction conditions which have been described above for step i).

The component b) is preferably selected from among polymers which comprise, in polymerized/copolymerized form,

I) at least one styrene compound of the formula

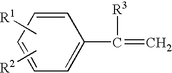

where

R¹ and R² are each, independently of one another, hydrogen, C₁-C₃₀-alkyl, hydroxy, alkoxy or halogen, R³ is hydrogen or C₁-C₈-alkyl, and

II) if desired, at least one monomer which is different from I), is copolymerizable therewith and has at least one α,β-ethylenically unsaturated double bond.

The styrene compound is preferably selected from among styrene, α-methylstyrene, o-chlorostyrene and the isomeric vinyltoluenes.

The monomers II) are preferably selected from among esters of α,β-ethylenically unsaturated monocarboxylic and/or dicarboxylic acids with C₁-C₃₀-alkanols, esters of vinyl alcohol or allyl alcohol with Cₗ-C₃₀-monocarboxylic acids, vinyl ethers, vinyl halides, vinylidene halides, C₂-C₈-monoolefins, nonaromatic hydrocarbons having at least two conjugated double bonds, N-vinyl amides, N-vinyl lactams, primary amides of α,β-ethylenically unsaturated monocarboxylic acids, vinyl- and allyl-substituted heteroaromatic compounds, α,β-ethylenically unsaturated nitriles and mixtures thereof.

Preferred monomers II) are, for example, vinyl formate, vinyl acetate, vinyl propionate, vinyl n-butyrate, vinyl stearate, vinyl laurate, vinyl chloride, vinylidene chloride, ethylene, propylene, butadiene, isoprene, chloroprene, methyl vinyl ether, ethyl vinyl ether, butyl vinyl ether, dodecyl vinyl ether, methyl (meth)acrylate, methyl ethacrylate, ethyl (meth)acrylate, tert-butyl (meth)acrylate, n-octyl (meth)acrylate, ethylhexyl (meth)acrylate, N-vinylformamide, N-vinylacetamide, N-vinylpropionamide, N-vinylpyrrolidone, N-vinylpiperidone, N-vinylcaprolactam, acrylamide, methacrylamide, ethacrylamide, 2- and 4-vinylpyridine, 2- and 4-allylpyridine, N-vinylimidazole, acrylonitrile, methacrylonitrile and mixtures thereof.

The component b) is more preferably selected from among polymers which comprise, in polymerized/copolymerized form,

I) from 50 to 100% by weight, based on the total weight of the components I) to III), of at least one styrene compound of the formula

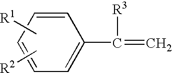

where

R¹, R² and R³ are each, independently of one another, hydrogen or C₁-C₈-alkyl,

II) from 0 to 50% by weight, based on the total weight of the components I) to III), of at least one compound selected from among dienes having conjugated double bonds, acrylonitrile, methacrylonitrile and mixtures thereof and

III) from 0 to 40% by weight of at least one monoethylenically unsaturated monomer which is different from I) and II) and is copolymerizable therewith.

The polymers b) are prepared, for example, by free-radical polymerization using customary methods known to those skilled in the art. These include free-radical polymerization in bulk, emulsion, suspension and in solution, preferably emulsion and solution polymerization. The polymerization temperature is generally from 30 to 120° C., preferably from 40 to 100° C. The polymerization medium for solution polymerization can consist entirely of an organic solvent or can be a mixture of water and at least one water-miscible, organic solvent. Preferred organic solvents are, for example, alcohols such as methanol, ethanol, n-propanol, isopropanol, n-butanol, ketones such as acetone and methyl ethyl ketone, tetrahydrofuran, etc. Solution polymerization can be carried out either as a batch process or in the form of a feed stream process, including monomer feed stream methods, stepwise methods and gradient methods. Preference is generally given to the feed stream process, in which part of the polymerization mixture may, if desired, be placed in the polymerization vessel, the vessel is heated to the polymerization temperature and the remainder of the polymerization mixture is subsequently introduced as one or more physically separate feed streams, either continuously, stepwise or according to a concentration gradient while maintaining the polymerization in the polymerization zone.

Initiators used for the free-radical polymerization are usually peroxo or azo compounds. These include, for example, dibenzoyl peroxide, tert-butyl perpivalate, tert-butyl per-2-ethyl-hexanoate, di-tert-butyl peroxide, 2,5-dimethyl-2,5-di(tert-butylperoxy)hexane, aliphatic or cycloaliphatic azo compounds, e.g. 2,2′-azobis(isobutyronitrile), 2,2′-azobis(2-methyl-butyronitrile), 2,2′-azobis(2,4-dimethylvaleronitrile), 1,1′-azobis(1-cyclohexanecarbonitrile), 2-(carbamoylazo)-isobutyronitrile, 4,4′-azobis(4-cyanovaleric acid) and their alkali metal and ammonium salts, e.g. the sodium salt, dimethyl 2,2′-azobisisobutyrate, 2,2′-azobis[2-(2-imidazolin-2-yl)-propane], 2,2′-azobis(2-amidinopropane) and the acid addition salts of the latter two compounds, e.g. the dihydrochlorides.

Further suitable initiators are hydrogen peroxide, hydroperoxides in combination with reducing agents and per salts. Suitable hydroperoxides are, for example, t-butyl hydroperoxide, t-amyl hydroperoxide, cumene hydroperoxide and pinane hydroperoxide, in each case in combination with, for example, a salt of hydroxymethane sulfinic acid, an iron(II) salt or ascorbic acid. Suitable per salts are, in particular, alkali metal peroxodisulfates.

The amount of initiator is generally in the range from about 0.01 to 2% by weight, based on the total weight of the monomers to be polymerized.

To obtain the desired molecular weight, a regulator may be employed. Suitable regulators are, for example, aldehydes such as formaldehyde, acetaldehyde, propionaldehyde, n-butyraldehyde and isobutyraldehyde, formic acid, ammonium formate, hydroxylammonium sulfate and hydroxylammonium phosphate. It is also possible to use regulators which contain organically bound sulfur, e.g. di-n-butyl sulfide, di-n-octyl sulfide, diphenyl. sulfide, etc., or regulators which contain sulfur in the form of SH groups, e.g. n-butyl mercaptan, n-hexyl mercaptan or n-dodecyl mercaptan. Water-soluble, sulfur-containing polymerization regulators, for example hydrogensulfites and disulfites, are also suitable. Further suitable regulators are allyl compounds such as allyl alcohol or allyl bromide, benzyl compounds such as benzyl chloride or alkyl halides such as chloroform or tetrachloromethane.

If desired, one or more polymerization initiators are added to the polymer solution subsequent to the polymerization reaction and the polymer solution is heated, for example to the polymerization temperature or to temperatures above the polymerization temperature, to complete the polymerization. Initiators suitable for this purpose are the above-described azo initiators and also all other customary initiators which are suitable for free-radical polymerization in aqueous solution, for example peroxides, hydroperoxides, peroxodisulfates, percarbonates, peroxo esters and hydrogen peroxide. In this way, the polymerization reaction is brought to a higher conversion, e.g. 99.9%.

The present invention also provides a process for preparing a polymer composition as described above which comprises bringing at least one polyisobutene-containing component a) and at least one polymer b) which is different therefrom into intimate contact with one another.

Preference is given to the component a) comprising at least one polyisobutene derivative and the component b) comprising at least one polymer which each have at least one complementary functional group capable of reacting with the other and the components being brought into contact with one another under conditions under which at least part of the functional groups react.

As regards the preparation of the polymer compositions of the present invention, for example by compounding with or without solvent, coextrusion or kneading, reference may be made to Ullmann's Encyclopedia of Technical Chemistry, 6th edition, 2000 Electronic Edition, chapter “Polymer Blends”, which is hereby fully incorporated by reference.

The invention is illustrated by the following nonlimiting examples.

### EXAMPLES

1. Reaction of a Polyisobutene with a Styrene-Butadiene Copolymer in a Friedel-Crafts Reaction

15 g of a polyisobutene having a number average molecular weight Mₙ, of 32,000, a polydispersity PD of 2.0, an α-olefin content of 60% and a β-olefin content of 33% are dissolved in 50 ml of CHCl₃. 100 g of a copolymer of butadiene and styrene (Krylene 1500® from Bayer AG) are dissolved in 650 ml of CHCl₃. The solutions are mixed in a 2 l four-necked flask. A sample is taken and 2.21 g of BF₃-phenol complex are subsequently added at room temperature to the remaining mixture. The mixture is maintained at a temperature in the range from 20 to 30° C. for 8 hours and is then introduced into 3 l of isopropanol while stirring vigorously, resulting in precipitation of the polymer as a grayish white, rubber-elastic mass. It is dried overnight in a drying oven at 70° C., 200 mbar: 102 g=87% yield. The sample is worked up analogously.

The ¹H-NMR spectrum of the sample displays two vinylidene proton signals (δ=4.7 and 4.8 ppm), which have disappeared in the product. After a storage time of 6 weeks, polyisobutene sweats from the sample (sticky surface), while the product is unchanged.

2. Reaction of a Polyisobutene with Phenol in a Friedel-Crafts Reaction

100 g (5.6 mmol) of a polyisobutene (Mₙ=18,000, PD=2.1, α-olefin content=65%, β-olefin content=30%) are dissolved in 500 ml of CHCl₃. 2.4 g of phenol (25 mmol) are dissolved in 10 ml of CHCl₃. The solutions are mixed in a 1 l four-necked flask. 2.56 g (10 mmol) of BF₃-phenol complex are added at room temperature. The mixture is stirred at room temperature for 8 hours, then introduced into 2 l of methanol while stirring vigorously, resulting in precipitation of the polymer as a light-colored, tough, elastic mass. This is separated off and dried overnight in a drying oven at 70° C., 200 mbar: 95 g (=94.5% yield) of 4-polyisobutenylphenol.

The ¹H-NMR spectrum of the sample in CD₂Cl₂ displays the following signals: 7.2 ppm (doublet, 2H), 6.7 ppm (doublet, 1.9H), 4.8 ppm (singlet, 1H), 1.75 ppm (singlet, 2H), 1.5 ppm (singlet, 660H), 1.05 ppm (singlet, 1950H).

3. Reaction of a Polyisobutene with Maleic Anhydride (Ene Reaction)

382 g (15 mmol) of a polyisobutene (Mₙ=25,000, PD=2.0, α-olefin content=69%, β-olefin content=25%) are placed in a 500 ml four-necked flask fitted with a superposed air condenser (30 cm). The polyisobutene is heated to 170° C. under nitrogen, and. is then evacuated to 5 mbar for 30 minutes. 2.6 g of maleic anhydride are added and the mixture is stirred at 215° C. under a gentle stream of nitrogen for 130 minutes. A further 2 g of maleic anhydride are then added and the mixture is stirred at 225° C. for another 110 minutes. Excess maleic anhydride is removed. at 180° C./3 mbar on a rotary evaporator. The residue is dissolved in hexane, filtered under pressure and once again evaporated on a rotary evaporator (up to 180° C./3 mbar). This gives 360 g of a tough, elastic mass composed. of polyisobutenylsuccinic anhydride; yield 94%.

The infrared spectrum of the sample displays CO vibrations (V_{co}) at 1860 and 1779 cm⁻¹. The saponification number (SN) was 3.5.

4. Sulfonation of a Polyisobutene

250 g (0.01 mol) of a polyisobutene having a mean molar mass of Mₙ =25,000 dalton and a polydispersity M_{w}/Mₙ=2.0 and an α-olefin content of 69% are dissolved in 1 l of n-hexane. At 20-25° C., 2 g (0.02 mol.) of acetic anhydride are added, followed by 1.5 g (0.015 mol) of sulfuric acid. The mixture is allowed to react overnight and the reaction is stopped by means of 200 ml of methanol. The methanol phase is separated off and the reaction mixture is washed another 3 times with 200 ml of methanol. The hexane phase is evaporated at 140° C./5 mbar on a rotary evaporator. This gives 248 g of a light-colored, resin-like, elastic mass.

¹H-NMR (in CDCl₃, 16 scans at 500 MHz): 5.4 ppm (singlet, 0.9 H); 5.3 ppm (singlet, 1.1 H); 3.8 ppm (singlet, 1 H); 2.2 ppm (singlet, 0.9 H); 1.5 ppm (singlet, 890 H); 1.05 ppm (singlet, 2680 H)

5. Reaction with Thiols

250 g (0.01 mol) of a polyisobutene having a mean molar mass of Mₙ=25,000 dalton and a polydispersity M_{w}/Mₙ=2.0 and an α-olefin content of 69% are dissolved in 500 ml of n-hexane, and 2 g (0.018 mol) of thiphenol are then added. The reaction is started by addition of 1.3 g of BF₃-phenol complex. The mixture is allowed to react overnight (total of 18 hours) and the reaction is stopped by means of 200 ml of methanol. The methanol phase is separated off and the reaction mixture is washed another 3 times with 200 ml of methanol. The hexane phase is evaporated at 140° C./5 mbar on a rotary evaporator. This gives 245 g of a light-colored, resin-like, elastic mass: polyisobutenyl, phenyl sulfide.

¹H-NMR (in CD₂Cl₂, 16 scans at 500 MHz): 7.5 ppm (doublet with fine separation, 2 H); 7.3 ppm (superimposed triplets, 3 H); 1.5 ppm (singlet, 880 H); 1.05 ppm (singlet, 2700 H)

6. Epoxide of Polyisobutene

A solution of 500 g (0.02 mol) of a polyisobutene having a mean molar mass of Mₙ=25,000 dalton and a polydispersity M_{w}/Mₙ=2.0 and an α-olefin content of 69% in 600 ml of toluene is placed in a 2 l four-neck flask. 0.9 g (20 mmol) of formic acid is subsequently added. The mixture is heated to 80° C. and 1.4 g (20 mmol) of H₂O₂ solution are added dropwise. The mixture is stirred at 90° C. for 45 minutes. After cooling to room temperature, the aqueous phase is separated off. 0.5 g (10 mmol) of formic acid is subsequently added to the organic solution, the mixture is once again heated to 80° C. and 0.7 g (10 mmol) of H₂O₂ solution is added dropwise. After 1 hour at 90° C., the aqueous phase is separated off and the organic phase is washed with 100 ml of saturated NaHCO₃ solution, 100 ml of water and 100 ml of saturated FeSO₄.7H₂O solution. The organic phase is evaporated at 100° C./5 mbar on a rotary evaporator. 496 g of polyisobutene epoxide are obtained as a light-colored, soft resin-like mass

¹H-NMR (in CD₂Cl₂, 16 scans at 500 MHz): 2.6 ppm (doublet with fine separation, 0.7 H); 2.55 ppm (doublet with fine separation, 0.7 H); 1.85 ppm (singlets, 3×0.3 H); 1.8 ppm (singlets, 3×0.3 H); 1.5 ppm (singlet, 880 H), 1.05 ppm (singlet, 2700 H)

7. Aminoalkylated Polyisobutenylphenol

580 g of a polyisobtuenylphenol prepared as described in example 2 are dissolved in 580 g of xylene and placed in a 2 l four-neck flask. 7 g of formaldehyde solution (37%) are added and the mixture is stirred at 90° C. for 30 minutes. 10 g of dimethylamine solution (40%) are then added and water is distilled out at 160° C. The solution is subsequently evaporated at 140° C./5 mbar on a roatary evaporator. This gives 567.5 g of a highly viscous liquid.

According to 1H-NMR (FT-NMR, 500 MHz, 16 scans, CD₂Cl₂), polyisobutenylphenol is no longer present.

New signals can be seen at 3.6 ppm (Ar—CH₂—N(CH₃)₂) and 2.28 ppm (Ar—CH₂—N(CH₃)₂), and these correspond to an N,N-dimethyl-2-hydroxy-5-polyisobutenylbenzylamine.

We claim:

1. A polymer composition comprising:
a) at least one polyisobutene-containing component selected from among medium molecular weight, reactive polyisobutene having a number average molecular weight Mₙ in the range from 5000 to 80000 dalton and a content of terminal double bonds of at least 50 mol %, derivatives of this medium molecular weight, reactive polyisobutene and mixtures thereof,
b) at least one polymer which is different from a).

2. A composition as claimed in claim 1, comprising, as component a), at least one polyisobutene having a content of α- and/or β-double bonds of at least 60 mol %.

3. A composition as claimed in claim 1, comprising, as component a), at least one polyisobutene derivative which is obtainable by reaction of at least part of the double bonds present in a medium molecular weight, reactive polyisobutene in a single-stage or multistage functionalization selected from among:
i) reaction with a compound containing at least one aromatic or heteroaromatic group in the presence of an alkylation catalyst to give a compound alkylated by polyisobutene,
ii) reaction with a peroxy compound to give an at least partially epoxidized polyisobutene,
iii) reaction with an alkene which has an electrophilically substituted double bond in an ene reaction,
iv) reaction with carbon monoxide and hydrogen in the presence of a hydroformylation catalyst to give an at least partially hydroformylated polyisobutene,
v) reaction with hydrogen sulfide or a thiol to give a polyisobutene which is at least partially functionalized by thio groups,
vi) reaction with a silane in the presence of a silylation catalyst to give a polyisobutene which is at least partially functionalized by silyl groups,
vii) reaction with a halogen or a hydrogen halide to give an at least partially halogenated polyisobutene,
viii) reaction with a borane and subsequent oxidative cleavage to give an at least partially hydroxylated polyisobutene,and
ix) reaction with SO₃ or a compound capable of releasing SO₃ to give a polyisobutene which is at least partially functionalized by sulfo groups.

4. A composition as claimed in claim 3, wherein the compound obtained in step i) is subjected to further functionalization by reaction with at least one aldehyde and at least one amine which has at least one primary or secondary amine function to give a compound which is alkylated by polyisobutene and additionally at least partially aminoalkylated.

5. A composition as claimed in claim 3, wherein, in step iii), maleic anhydride is used as alkene and a polyisobutene which is at least partially functionalized by succinic anhydride groups is obtained.

6. A composition as claimed in claim 5, wherein the polyisobutene which is partially functionalized by succinic anhydride groups is subjected to a further functionalization selected from among:
α) reaction with at least one amine to give a polyisobutene which is at least partially functionalized by succinimide groups and/or succinamide groups,
β) reaction with at least one alcohol to give a polyisobutene which is at least partially functionalized by succinic ester groups, and
γ) reaction with at least one thiol to give a polyisobutene which is at least partially functionalized by succinic thioester groups.

7. A composition as claimed in claim 3, wherein the hydroformylated polyisobutenes obtained in step iv) are subjected to a further functionalization selected from among:
A) reaction in the presence of an oxidant to give a polyisobutene which is at least partially functionalized by carboxyl groups,
B) reaction with hydrogen in the presence of a hydrogenation catalyst to give a polyisobutene which is at least partially functionalized by alcohol groups,
C) reaction with hydrogen and ammonia or a primary or secondary amine in the presence of an amination catalyst to give a polyisobutene which is at least partially functionalized by amine groups.

8. A composition as claimed in claim 3, wherein the polyisobutene which is obtained in step ix) and has been partially functionalized with sulfonic acid groups is subjected to neutralization with a base.

9. A composition as claimed in any of the preceding claims, wherein the component b) is selected from among elastomers having a glass transition temperature T_{G} of not more than 0° C., preferably not more than −10° C.

10. A composition as claimed in claim 9, wherein the elastomer is selected from among: acrylate rubbers (ACM), chlorosulfonated polyethylene (A-CSM), copolymers of alkyl acrylates with ethylene (AEM), polyester urethanes (AU), brominated butyl rubbers (BIIR), polybutadiene (BR), chlorinated butyl rubbers (CIIR), chlorinated polyethylene (CM), epichlorohydrin (CO), polychloroprene (CR), sulfurated polyethylene (CSM), ethylene oxide-epichlorohydrin copolymers (ECO), ethylene-acrylonitrile copolymers (ENM), epoxidized natural rubbers (ENR), ethylene-propylene-diene terpolymers (EPDM), ethylene-propylene copolymers (EPM), polyether urethanes (EU), ethylene-vinyl acetate copolymers (EVM), fluorinated rubbers (FKM), fluorosilicone rubbers (FVMQ), propylene oxide-allyl glycidyl ether copolymers (GPO), isobutene-isoprene copolymers (IIR), isoprene rubbers (IR), nitrile rubbers (NBR), natural rubber (NR), thioplastics (OT), styrene-butadiene rubbers (SBR), carboxyl-containing acrylonitrile-butadiene rubbers (XNBR), carboxyl-containing styrene-butadiene rubbers and mixtures thereof.

11. A composition as claimed in any of the preceding claims, wherein the component b) is selected from among polymers which comprise, in polymerized/copolymerized form
I) at least one styrene compound of the formula 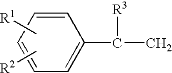
where
R¹ and R² are each, independently of one another, hydrogen, C₁-C₃₀-alkyl, hydroxy, alkoxy or halogen, R³ is hydrogen or C₁-C₈-alkyl, and,
II) if desired, at least one monomer which is different from I), is copolymerizable therewith and has at least one α,β-ethylenically unsaturated double bond.

12. A process for preparing a polymer composition as described in any of claims 1 to 11 which comprises bringing at least one polyisobutene-containing component a) and at least one polymer b) which is different therefrom into intimate contact with one another.

13. A process as claimed in claim 12, wherein the component a) comprises at least one polyisobutene derivative and the component b) comprises at least one polymer which each have at least one complementary functional group capable of reacting with the other and the components are brought into contact under conditions under which. at least part of the functional groups react.

14. A process for preparing a polyisobutene derivative by reaction of at least part of the double bonds present in a medium molecular weight, reactive polyisobutene in a single-stage or multistage functionalization selected from among:
i) reaction with a compound containing at least one aromatic or heteroaromatic group in the presence of an alkylation catalyst to give a compound alkylated by polyisobutene, and, if desired, reaction in a further functionalization,
ii) reaction with a peroxy compound to give an at least partially epoxidized polyisobutene,
iii) reaction with an alkene which has an electrophilically substituted double bond in an ene reaction and, if desired, reaction in a further functionalization,
iv) reaction with carbon monoxide and hydrogen in the presence of a hydroformylation catalyst to give an at least partially hydroformylated polyisobutene and, if desired, reaction in a further functionalization,
v) reaction with hydrogen sulfide or a thiol in the presence of a catalyst to give a polyisobutene which is at least partially functionalized by thio groups,
vi) reaction with a silane in the presence of a silylation catalyst to give a polyisobutene which is at least partially functionalized by silyl groups,
vii) reaction with a halogen or a hydrogen halide in the presence of a-catalyst or electromagnetic radiation to give an at least partially halogenated polyisobutene,
viii) reaction with a borane and subsequent oxidative cleavage to give an at least partially hydroxylated polyisobutene, and
ix) reaction with SO₃ or a compound capable of releasing SO₃ to give a polyisobutene which is at least paretially functionalized by sulfo groups.

15. A polyisobutene derivative obtainable by a process as claimed in claim 14.
